(19) United States
(12) Patent Application Publication
(10) Pub. No.: US 2012/0068628 A1
(43) Pub. Date: Mar. 22, 2012

(54) DISPLAY DEVICE

(76) Inventors: Tsuyoshi Hioki, Yokohama-shi (JP); Yutaka Nakai, Yokohama-shi (JP)

(21) Appl. No.: 13/242,891

(22) Filed: Sep. 23, 2011

Related U.S. Application Data
(63) Continuation of application No. PCT/JP09/66971, filed on Sep. 29, 2009.

(51) Int. Cl. H05B 37/02

(52) U.S. Cl. 315/312

(57) ABSTRACT

According to one embodiment, a display device in which one display screen is formed by a plurality of one-dimensional device structures is disclosed. Each of the one-dimensional device structures includes a pixel array including a plurality of pixels arranged linearly, a first driving line group configured to drive the pixel array, a plurality of inter-pixel circuits arranged between a first pixel and a second pixel of the plurality of pixels to perform a sequential operation from the first pixel to the second pixel, and a second driving line group configured to drive the inter-pixel circuits.

### CROSS-REFERENCE TO RELATED APPLICATIONS

This application is a Continuation Application of PCT Application No. PCT/JP2009/066971, filed Sep. 29, 2009, the entire contents of which are incorporated herein by reference.

### FIELD

Embodiments described herein relate generally to a display device that performs matrix driving.

### BACKGROUND

So-called flat panel displays (FPDs) such as liquid crystal displays (LCDs), plasma display panels (PDPs), organic light emitting displays (OLEDs), and field emission displays (FEDs) mainly use matrix driving methods to drive two-dimensionally arrayed pixels. The matrix driving methods are classified into the simple matrix driving method and the active matrix driving method. Both methods make wiring run across a grid to drive pixels arranged at the intersections of the vertical and horizontal lines. Hence, main signal circuits configured to drive the pixels are provided not for each pixel but on a portion called a frame outside the pixels instead, thereby enabling the display operation. For example, in an LCD that performs active matrix (AM) driving, an active element formed from, for example, a thin-film transistor (TFT) is added to each pixel so as to serve as a switch to select the pixel. Each TFT generally adopts a three-terminal element structure. The gate electrode is connected to a gate line, and the source (or drain) electrode is connected to a signal line. The signal lines and the gate lines are arranged on the grid like vertical and horizontal lines of the matrix wiring. The other drain (or source) electrode of each TFT is connected to a corresponding pixel electrode. For example, a potential is applied to a given gate line to make a current flow between the sources and drains of TFTs (this will be defined as an on-state hereinafter). This allows application of a potential, via the signal lines, to the pixel electrodes of the pixel electrode group connected to the TFTs so as to control the LC (Liquid Crystal) to a desired light valve state. In addition, a potential is applied to the remaining gate lines except the above-described gate line so a current barely flows between the sources and drains (this will be defined as an off-state hereinafter). This can make the pixel electrodes connected to the gate lines via the TFTs insensitive to the influence of the potential of each signal line.

Hence, setting a gate line in the on-state and the remaining gate lines in the off-state and sequentially scanning the on-state of the gate lines enables each of the two-dimensionally arrayed pixels to be in a desired display state during a predetermined period.

On the other hand, to avoid a manufacturing method that leads to upsizing of the manufacturing apparatus because of use of a large two-dimensional substrate, an attempt has been made to construct a two-dimensional display device by integrating device structures (to be referred to as one-dimensional device structures hereinafter) each having pixels one-dimensionally arrayed linearly.

### BRIEF DESCRIPTION OF THE DRAWINGS

FIG. 1 is a view showing a display device according to the first embodiment.

FIG. 2 is a view showing the cross section along a line A-A′ in FIG. 1.

FIG. 3 is a view showing the cross section along a line B-B′ in FIG. 1.

FIG. 4 is a view showing a pixel array in FIG. 2.

FIG. 5 is a view schematically showing light wave propagation from a light source and a light extraction operation at a pixel position.

FIG. 6A is a view showing the cross section along a line A-A′ in FIG. 5.

FIG. 6B is a view showing the cross section along a line B-B′ in FIG. 5.

FIG. 7 is a view showing an example of the sequential operation of the pixel array in FIG. 4.

FIG. 8 is a schematic view showing the operation configuration in FIG. 7.

FIG. 9 is a view showing an example of the arrangement of an inter-pixel circuit according to the first embodiment.

FIG. 10 is a view showing the overall arrangement of the display device according to the first embodiment.

FIG. 11 is a view schematically showing the sequential operation of the display device according to the first embodiment.

FIG. 12 is a schematic view of the display device according to the first embodiment which implements an arbitrary number of pixels.

FIG. 13 is a view showing a display device according to the second embodiment.

FIG. 14 is a view showing the cross section along a line A-A′ in FIG. 13.

FIG. 15 is a view showing the cross section along a line B-B′ in FIG. 13.

FIG. 16 is a view showing an example of a circuit arrangement according to the second embodiment.

FIG. 17 is a view showing the overall arrangement of the display device according to the second embodiment.

FIG. 18 is a view showing a display device according to the third embodiment.

FIG. 19 is a view showing the cross section along a line A-A′ in FIG. 18.

FIG. 20 is a view showing the cross section along a line B-B′ in FIG. 18.

FIG. 21 is a view showing an example of a circuit arrangement according to the third embodiment.

### DETAILED DESCRIPTION

In general, according to one embodiment, a display device in which one display screen is formed by a plurality of one-dimensional device structures is disclosed. Each of the one-dimensional device structures includes a pixel array including a plurality of pixels arranged linearly, a first driving line group configured to drive the pixel array, a plurality of inter-pixel circuits arranged between a first pixel and a second pixel of the plurality of pixels to perform a sequential operation from the first pixel to the second pixel, and a second driving line group configured to drive the inter-pixel circuits.

### First Embodiment

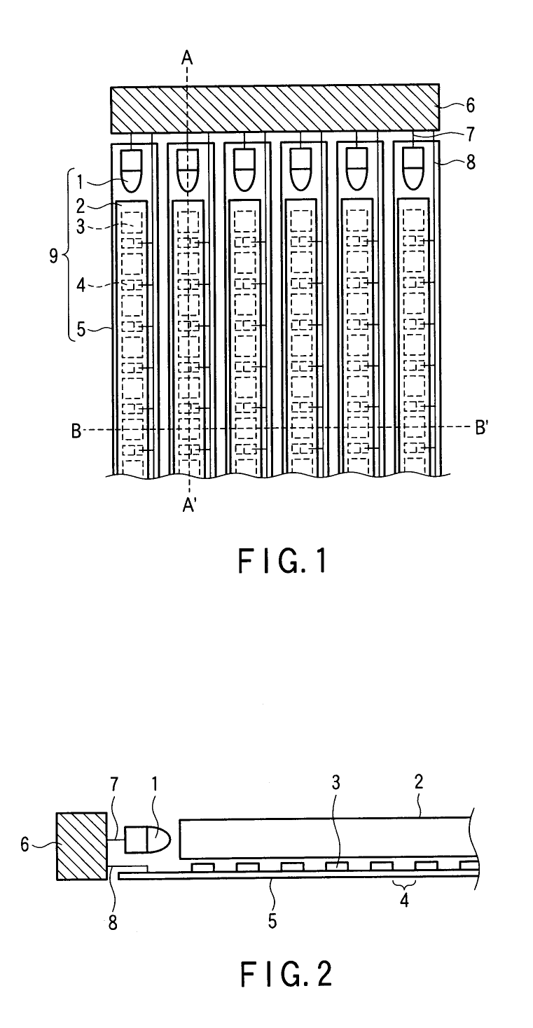

FIG. 1 is a view showing a display device according to the first embodiment. This device uses light wave propagation as the transmission means on the signal line side. This device includes, as the arrangement on the signal line side, a light source 1, a light wave propagation 2 configured to guide light emitted by the light source 1 while satisfying the total reflection condition, a light extraction element 3 that allows extraction of the guided light from the light wave propagation 2 to the outside by selectively and locally relaxing the total reflection condition, and a circuit board 5. The circuit board 5 forms inter-pixel circuits 4 between the adjacent light extraction elements 3. The arrangement on the signal line side includes the light extraction elements 3 arrayed linearly in the light wave propagation direction from the light source 1 and will be referred to as a “one-dimensional device structure” hereinafter. A plurality of one-dimensional device structures 9 are arranged in parallel and connected to a driving circuit unit 6 by light source driving lines 7 and inter-pixel driving lines 8, thereby constructing the display device.

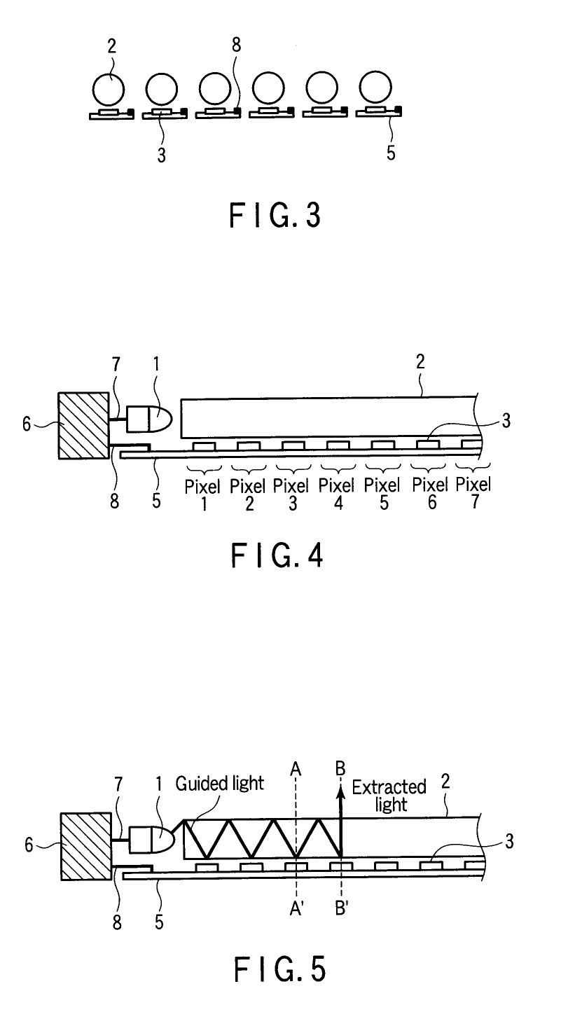

FIG. 2 schematically shows an example of a cross-sectional structure along a line A-A′ in FIG. 1. The plurality of light extraction elements 3 are arranged at a predetermined interval in the direction of light wave propagation in the light wave propagation 2 from the light source 1. The inter-pixel circuits 4 are formed on the circuit board 5 between the adjacent light extraction elements 3. FIG. 3 schematically shows an example of a cross-sectional structure along a line B-B′ in FIG. 1. As shown in FIG. 3, the plurality of light wave propagations 2 and the plurality of light extraction elements 3 are arranged at a predetermined interval in the direction of the cross section along a line B-B′ as well. Hence, the display device according to the first embodiment has the light extraction elements 3 arranged in a matrix.

FIG. 4 shows an example of the pixel arrangement of the one-dimensional device structure. As shown in FIG. 4, for example, pixel 1, pixel 2, pixel 3, . . . can be set sequentially from the region including the light extraction element 3 located close to the light source 1. This is because the optical operation of each pixel according to the embodiment is associated with the operation of the light extraction element 3.

FIG. 5 schematically shows the light extraction operation of pixel 4 in FIG. 4. As for the guided light in the light wave propagation 2, the total reflection condition of light guided in the light wave propagation 2 is satisfied in each of the pixel portions other than pixel 4, which do not make the light extraction elements 3 act on the light wave propagation. Hence, the light is guided in the light guide 2 without being extracted to the outside. To the contrary, the light extraction element 3 of pixel 4 acts on the light guide 2 so as to relax the total reflection condition on the interface between the light guide 2 and the light extraction element 3. For this reason, the light guided in the light wave propagation 2 is extracted from the light wave propagation 2 as extracted light.

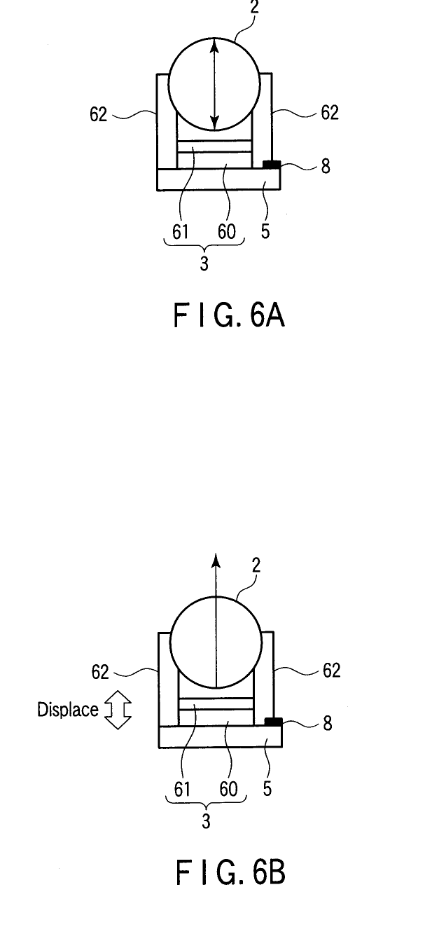

FIGS. 6A and 6B show the cross section along a line A-A′ and the cross section along a line B-B′ in FIG. 5. FIGS. 6A and 6B show a case in which a displacement element is used as the operation method of the light extraction element 3. The light extraction element 3 has the layered structure of a displacement element 60 and a light extraction layer 61. Spacers 62 define the interval between the light wave propagation 2 and the light extraction layer 61. As shown in FIG. 6A, when a gap exists between the light wave propagation 2 and the light extraction layer 61, the atmosphere (air) having a low refractive index exists. However, when the displacement element 60 is displaced, as shown in FIG. 6B, the light extraction layer 61 comes into contact with the light wave propagation 2.

In this embodiment, for example, a light-emitting diode (LED) having a wavelength of 450, 525, or 630 nm in the visible light range is used as the light source 1. As the light wave propagation 2, an acrylic resin having a refractive index of approximately 1.49 that is transparent to the visible light range is used. A structure obtained by forming an aluminum film having a thickness of approximately 100 nm and serving as a reflective surface on the lower surface (that is, the surface in contact with the displacement element 60) of a polyethylene resin film having a refractive index of approximately 1.53 and containing dispersed titanium oxide particles having a refractive index of approximately 2 is used as the light extraction layer 61. A material such as lead zirconate titanate capable of displacement caused by ferroelectricity upon electric field application is used as the displacement element 60. Hence, when a gap exists between the light wave propagation 2 and the light extraction layer 61, the light wave propagation 2 can hold the total reflection condition because it forms an interface to the air having a refractive index of approximately 1. However, when the displacement element 60 is displaced to bring the light extraction layer 61 into contact with the light wave propagation 2, the total reflection condition is relaxed in the portion of interest, and the guided light enters the light extraction layer 61. The light that has entered the light extraction layer 61 changes the light propagation direction by repeating refraction on the interface between the titanium oxide particles and polyethylene and reflection on the interface between polyethylene and aluminum. The light is thus extracted from the light wave propagation 2. Hence, it is possible to selectively and locally extract the guided light only in the region of pixel 4, as schematically illustrated in FIG. 5. In this case, the viewer who looks from above in FIG. 5 observes the light from the light source 1 only in the region of pixel 4.

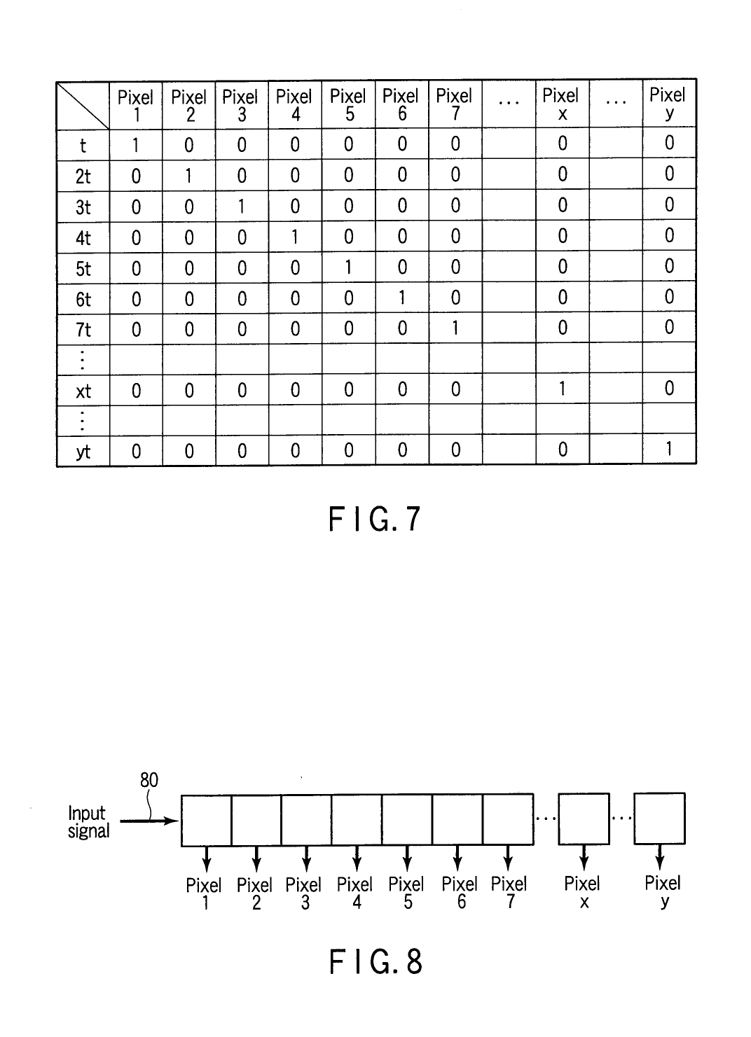

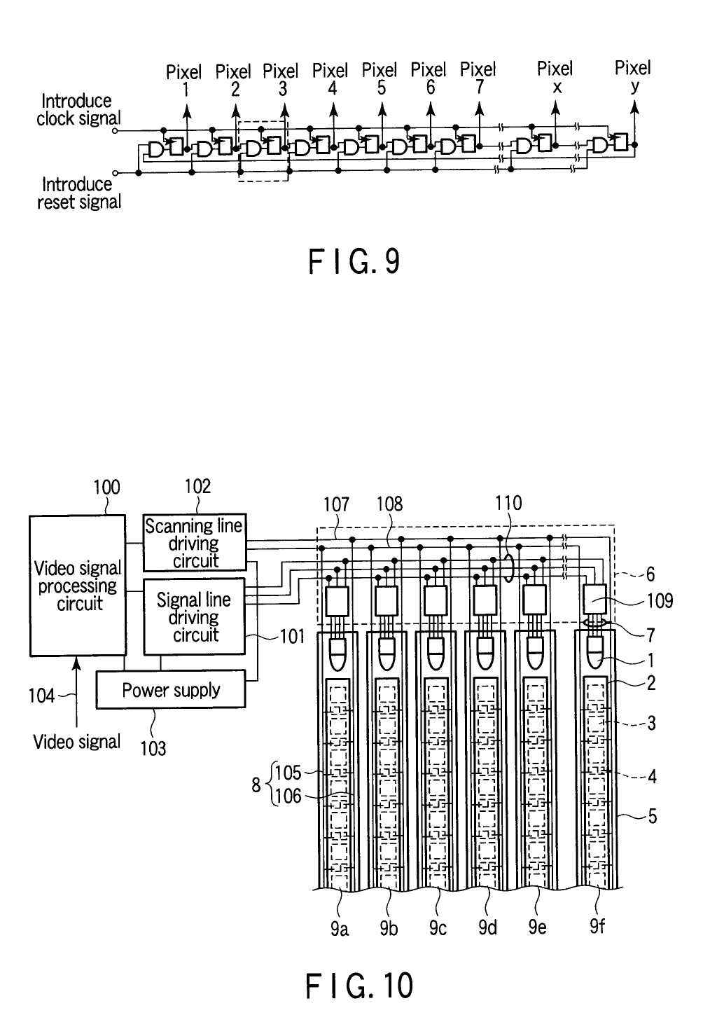

FIG. 7 shows the sequential operation of the one-dimensional device structure 9 shown in FIG. 4 in which y pixels are arrayed. Note that in FIG. 7, “0” represents a state in which the displacement element is not displaced, and “1” represents a state in which the displacement element is displaced to bring the light extraction layer 61 into contact with the light wave propagation 2. When only pixel x can perform the displacement operation in a period xt, the sequential light extraction operation from pixel 1 to pixel y is possible in a period yt, as shown in FIG. 7. This allows the one-dimensional device structure 9 to perform the same operation as the matrix operation of the display device. Hence, as shown in FIG. 8, the sequential operation of outputs is performed from pixel 1 to pixel 2, from pixel 2 to pixel 3, . . . , pixel y−1 to pixel y each time an input signal 80 is applied. FIG. 9 shows an example of the arrangement of the inter-pixel circuit capable of implementing this operation. The inter-pixel circuits shown in FIG. 9 enable the sequential operation of outputs of the pixels each time a clock signal is input. Note that this arrangement also allows introduction of a reset signal. This is because the state “1” that has reached pixel y in FIG. 7 needs to return to pixel 1 for the scanning operation of matrix driving.

Hence, the circuit arrangement surrounded by the broken line in FIG. 9 is arranged as each inter-pixel circuit of the circuit board in FIG. 1. A line corresponding to the clock signal and a line corresponding to the reset signal which are formed on the circuit board are connected to the driving circuit unit via an inter-pixel circuit driving line. This allows the single one-dimensional device structure to perform the sequential operation without providing scanning lines arranged in a matrix so as to intersect the light extraction elements of the one-dimensional device structure.

FIG. 10 shows an example of the arrangement of the entire display device according to this embodiment. This device includes a power supply 103 which supplies power to circuits 100 to 102, the video signal processing circuit 100 which receives and processes a video signal 104, the scanning line driving circuit 102 which performs display device control concerning scanning line driving based on a signal supplied from the video signal processing circuit 100, the signal line driving circuit 101 which performs display device control concerning signal line driving based on a signal supplied from the video signal processing circuit 100, and the driving circuit unit 6 connected to one-dimensional device structures 9a to 9f.

The clock bus line and the reset bus line from the scanning line driving circuit 102 are mainly connected to the driving circuit unit 6. Clock lines 105 and reset lines 106 of the one-dimensional device structures 9 are respectively connected in parallel with a clock bus line 107 and a reset bus line 108 in the driving circuit unit 6. Hence, the clock signal and the reset signal from the scanning line driving circuit 102 are introduced to the one-dimensional device structures 9a to 9f almost at the same timing. This indicates that the sequential operation between the pixels and the return operation to pixel 1 in the one-dimensional device structures 9a to 9f can be done in synchronism. Hence, an operation corresponding to the matrix operation can be performed even if the one-dimensional device structures 9a to 9f have no scanning lines that are wiring lines existing in the conventional display device along the B-B′ direction in FIG. 1.

In this device, the light wave propagation 2 corresponds to the signal line. Guided light adjustment in the driving circuit unit 6 is done by light source driving circuits 109 and the light source driving lines 7 connected to them. In this embodiment, the light source driving circuits 109 are arranged in the driving circuit unit 6, as described above. However, the light source driving circuits 109 may be provided on the light source side. The signal output from the signal line driving circuit 101 to drive each light source 1, power to be supplied from the power supply 103 to each light source 1, and the like are supplied via source driving bus lines 110 in the driving circuit unit 6.

FIG. 10 shows a case in which a light source incorporating three LED chips whose center wavelengths are 450, 525, and 630 nm, respectively corresponding to the three primary colors of red, green, and blue, is used as the light source. In this case, adjusting the operation of the three LED chips enables not only the light amount but also the chromaticity in each light source. Hence, full-color display is possible in one pixel without using subpixels of the three primary colors.

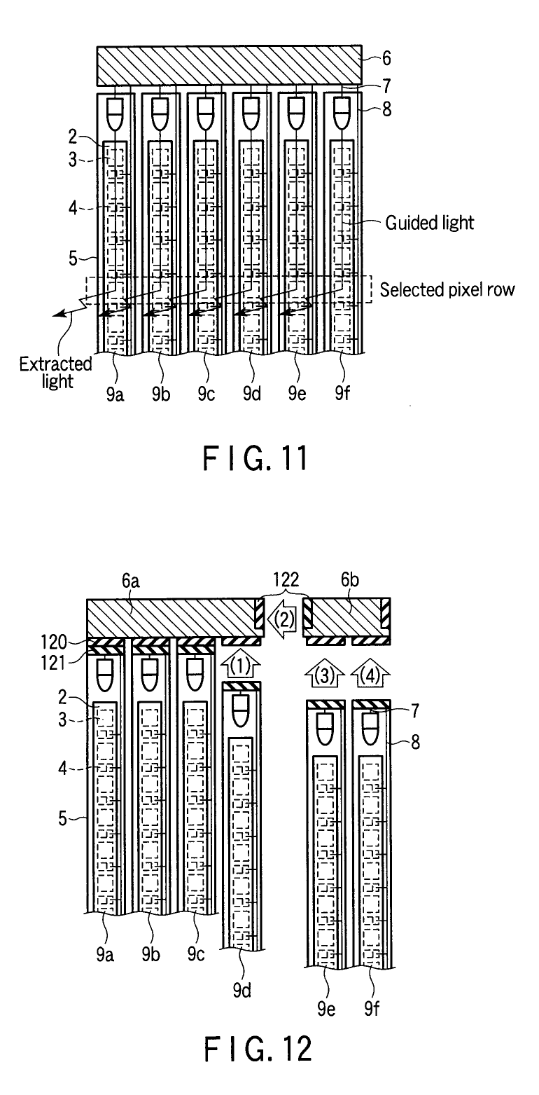

FIG. 11 shows a schematic example concerning the scanning operation of light emission in the pixel portion according to this embodiment. FIG. 11 illustrates a case in which pixel 5 that is the fifth pixel from the light source 1 in each of the one-dimensional device structures 9a to 9f performs the light extraction operation. Light emitted by the light source 1 of each of the one-dimensional device structures 9a to 9f and introduced to the light wave propagation 2 is guided from pixel 1 to pixel 4 while satisfying the total reflection condition. Pixel 5 is set in the light extraction state in all the one-dimensional device structures 9a to 9f connected to the driving circuit unit 6 in accordance with the clock signal from the above-described clock lines. For this reason, the light guided in the light wave propagation 2 can be extracted in the direction perpendicular to the drawing surface of FIG. 11. It is therefore possible to extract desired light from each pixel 5 by adjusting the wavelength and amount of light to be output from pixel 5. Performing this operation for each pixel sequentially from pixel 1 enables line-sequential image output on the entire display screen. More specifically, let y be the number of pixel arrays of the one-dimensional device structures 9a to 9f. For drawing by 60-Hz driving, the light extraction operation of each pixel is performed during a period of approximately 1/y/60 seconds. The sequential operation in the pixel array direction is performed to enable two-dimensional display using the image lag phenomenon.

FIG. 12 is a view schematically showing the extendibility of the display device according to this embodiment. More specifically, in this arrangement, to facilitate attachment/detachment of the one-dimensional device structures 9a to 9f and driving circuit units 6a and 6b, the driving circuit units (6a and 6b) and the one-dimensional device structures (9a to 9f) are connected by driving circuit connectors 120 and one-dimensional device structure connectors 121. The separated driving circuit units 6a and 6b are connected by a driving circuit extension connector 122. Assume that, for example, the leftmost to third one-dimensional device structures 9a to 9c in the drawing are connected. To additionally connect the fourth one-dimensional device structure 9d, the one-dimensional device structure 9d is connected to the driving circuit unit 6a in the direction of block arrow (1) to facilitate extension of the display screen. In addition, to add the fifth and sixth one-dimensional device structures 9e and 9f to the display device, the driving circuit unit 6b is connected via the driving circuit extension connector 122 for extension in the direction of block arrow (2). The one-dimensional device structures 9e and 9f are then connected in the directions of block arrows (3) and (4) to facilitate extension of the display screen.

As described above, the circuit that scans the pixels of each of the one-dimensional device structures 9a to 9f is formed in the one-dimensional device structure. The unit that operates the circuit can be connected using the driving circuit connector 120 and the one-dimensional device structure connector 121. It is therefore unnecessary to separately attach the scanning lines for the scanning operation and the wiring and driving circuits to be used to drive the scanning lines after the one-dimensional device structures are arbitrarily added, as in the conventional display device. This makes it possible to relatively flexibly construct a display device on site to a screen size optimum for the installation environment after a proper number of driving circuit units 6 with a certain arrangement and a proper number of driving circuit extension connectors 122 to be connected to the driving circuit units are prepared, and a proper number of one-dimensional device structures 9 are brought in, in accordance with the installation environment. It is therefore possible to dramatically increase the degree of freedom of installation of the display device relative to before.

### Second Embodiment

An embodiment of a display device based on organic electroluminescence (EL) that is a selfluminous device will be described below.

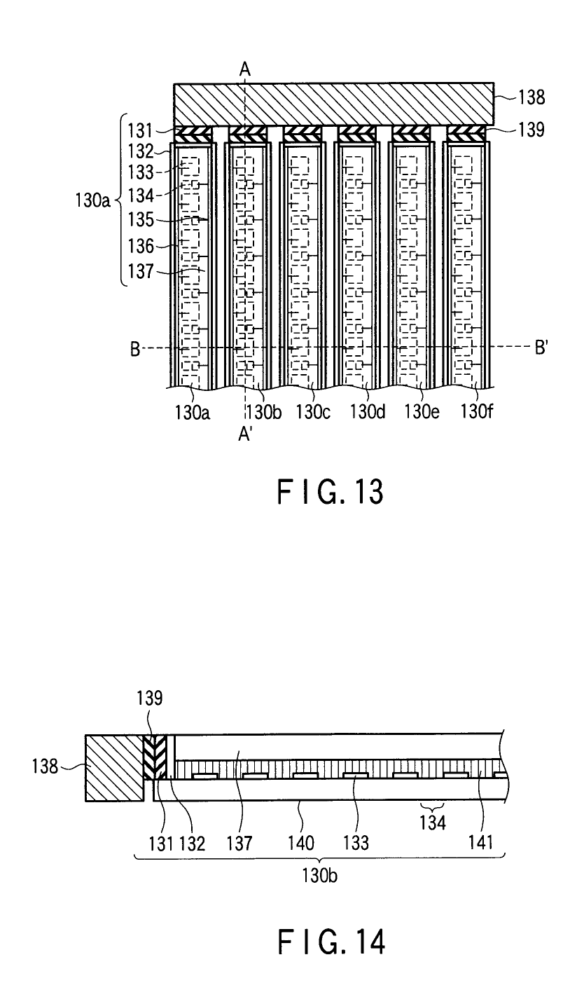

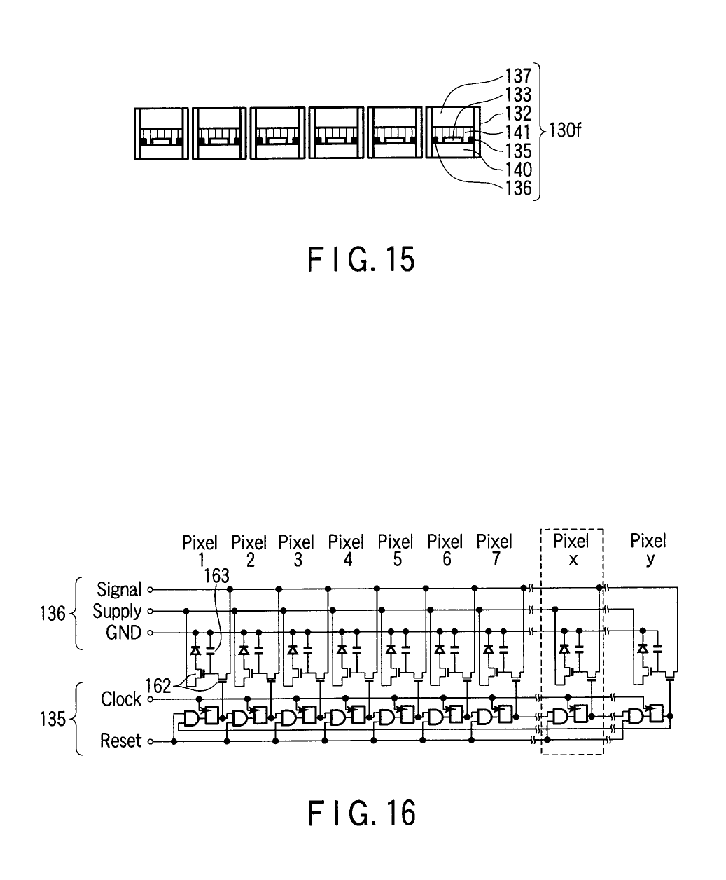

FIG. 13 shows an example of the arrangement of the display device according to this embodiment. FIGS. 14 and 15 show the cross section along a line A-A′ and the cross section along a line B-B′ in FIG. 13.

A one-dimensional device structure 130a of a plurality of one-dimensional device structures 130a to 130f includes a connector 131, a sealing portion 132, pixel electrodes 133 that constitute pixels, inter-pixel circuits 134 formed on a support substrate and arranged between the pixels, an inter-pixel circuit driving line 135 configured to operate the inter-pixel circuits 134, a light emission driving line 136 configured to drive an organic light-emitting layer 141 made of a multilayered film capable of organic EL corresponding to the pixels, and a countersubstrate 137. Note that the organic light-emitting layer 141 includes at least a layer that emits light by carrier recombination and a conductive layer facing the pixel electrodes. A carrier transport layer and the like may also be included. The one-dimensional device structures 130a to 130f of this arrangement are independent structures, as in the first embodiment, and are connected to driving circuit unit connectors 139 of a driving circuit unit 138 via the connectors 131. Hence, the inter-pixel circuit driving lines 135 and the light emission driving lines 136 of the one-dimensional device structures 130a to 130f are connected to the driving circuit unit 138 configured to drive the display device via the connection portions such as connectors.

In each of the one-dimensional device structures 130a to 130f, the pixels of the display device are one-dimensionally arrayed. That is, in FIG. 13, the pixels are arrayed linearly in the A-A′ direction. For this reason, adopting this arrangement enables to continuously manufacture each one-dimensional device structure in the longitudinal direction. For example, when manufacturing a display device as shown in FIG. 13, the current display device manufacturing method needs to form a two-dimensional screen using a region including all pixels for the desired screen size or a region including a plurality of such regions. In the device manufacturing step of this embodiment, however, the width necessary for the manufacture can approximately be localized to the width of the one-dimensional device structure in FIG. 13. Hence, a manufacturing apparatus with a small installation area can cope with the step.

For example, to drive the organic EL layer using an active element such as a thin-film transistor (TFT) of high image quality, the TFT needs to be formed on a support substrate 140. When, for example, low-temperature polysilicon is used as the TFT, the TFT manufacturing process extensively uses thin-film preparation and a photo-etching process under high vacuum similar to the semiconductor process. As a TFT process of forming a linear shape TFT, a manufacturing method as described in, for example, Jpn. Pat. Appln. KOKAI Publication No. 10-091097 has been examined. Use of this method enables main device formation using a manufacturing apparatus more compact than that for a conventional display device needing active elements. The light-emitting layer using organic EL can also be formed into a one-dimensional linear structure using a manufacturing method described in Jpn. Pat. Appln. KOKAI Publication No. 2004-123387, like the active element.

FIG. 16 shows an example of the circuit arrangement of the one-dimensional linear structure according to this embodiment. This circuit arrangement includes a signal line included in the light emission driving line, a feed line configured to cause the organic light-emitting layer 141 to emit light, a GND line connected to a reference potential such as ground, a clock line and a reset line included in the inter-pixel circuit driving line, and, for each pixel, a circuit arrangement indicated by the broken line in FIG. 16. Note that in FIG. 16, the pixel electrodes in FIG. 14 are defined as pixel 1, pixel 2, . . . , pixel y when viewed from the connector installation position, as in the first embodiment. In this case, y matches the total number of pixels of the one-dimensional device structure. Hence, y unit circuits indicated by the broken line in FIG. 16 are connected. As shown in FIG. 16, the inter-pixel circuit driving line and the light emission driving line can be arranged in the A-A′ direction in each one-dimensional device structure. Hence, each one-dimensional device structure can be connected at its end portion in the longitudinal direction to the driving circuit unit via a connector, as shown in FIG. 13. Wiring in the B-B′ direction is unnecessary, unlike the conventional display device.

The circuits surrounded by the clock line and the reset line of the inter-pixel circuit driving line in FIG. 16 control sequential scanning and are configured to shift the output sequentially from pixel 1 in accordance with signal input to the clock line. After being shifted up to pixel y, the output can shift to pixel 1 in accordance with signal input to the reset line. Hence, this sequential operation allows implementation of the functions of a wiring line called a scanning line or a data line and a circuit therefore in the conventional display device. The circuit arrangement surrounded by the inter-pixel circuit driving line 135 and the light emission driving line 136 is the arrangement for the pixel driving circuit of the organic EL layer. This circuit includes two transistors 162 and one capacitor 163 which are generally used in an OLED. However, application of the present embodiment is not limited to this arrangement, and a circuit arrangement in another form using a compensation circuit may be employed.

The output line from the circuit for controlling the sequential operation to each pixel is connected to the gate electrode of the first transistor 162 for pixel selection in the organic EL layer inter-pixel circuit 134. Note that in the conventional display device, the gate electrode of the first transistor 162 is connected to a scanning line or a data line. The source (or drain) electrode of the first transistor 162 is connected to the signal line included in the light emission driving line 136. The other of the drain (or source) electrode is connected to the capacitor 163 and the gate electrode of the second transistor 162. The source (or drain) electrode of the second transistor 162 is connected to the bus line serving as the current source to the organic light-emitting layer 141. The other of the drain (or source) electrode is connected to the organic light-emitting layer 141 serving as a diode structure including the organic EL layer. The capacitor 163 and the other line of the organic light-emitting layer 141 are connected to the GND line.

When the above-described circuit arrangement is adopted, a driving signal is introduced to each pixel via the inter-pixel circuit driving line 135, and signals corresponding to desired pixels are sequentially introduced via the light emission driving line (signal line) 136. This enables the sequential operation.

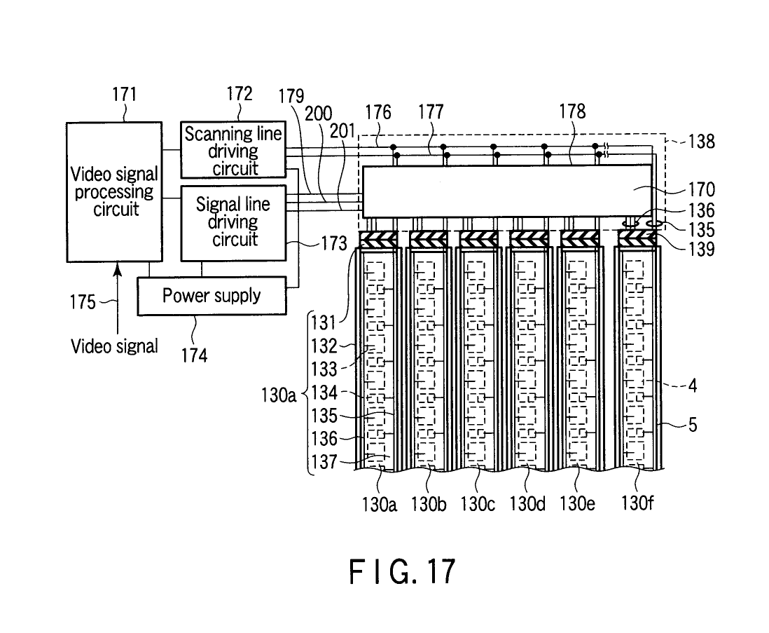

Hence, when the example of the overall arrangement of the display device as shown in FIG. 17 is adopted, no wiring lines corresponding to the scanning lines and data lines of the conventional display device need be added so as to intersect the one-dimensional device structures. This device includes a power supply 174 which supplies power to circuits 171 and 172, the video signal processing circuit 171 which receives and processes a video signal 175, the scanning line driving circuit 172 which performs display device control concerning scanning line driving based on a signal supplied from the video signal processing circuit 171, a signal line driving circuit 173 which performs display device control concerning signal line driving based on a signal supplied from the video signal processing circuit 172, and the driving circuit unit 138 connected to the one-dimensional device structures 130a to 130f.

A clock bus line 176 and a reset bus line 177 from the scanning line driving circuit 172 are mainly connected to the driving circuit unit 138. The clock lines and reset lines of the one-dimensional device structures 130a to 130f are respectively connected in parallel with the clock bus line 176 and the reset bus line 177 in the driving circuit unit 138. Hence, the clock signal and the reset signal from the scanning line driving circuit 172 are introduced to the one-dimensional device structures 130a to 130f almost at the same timing. This indicates that the sequential operation between the pixels and the return operation to pixel 1 in the one-dimensional device structures 130a to 130f can be done in synchronism. Hence, an operation corresponding to the matrix operation can be performed even if the one-dimensional device structures 130a to 130f have no scanning lines existing in the conventional display device.

The light emission driving lines 136 are connected to a signal driving circuit 170. The signal driving circuit 170 is connected to a signal bus line 179, a power source bus line 200, and a GND bus line 201 connected to the signal line driving circuit 173. This arrangement enables to implement a display device capable of the sequential operation. In addition, as shown in FIG. 12 of the first embodiment, adding the one-dimensional device structures and extending the driving circuit unit 138 allow easy changing of the screen size on a unitary row of pixels.

### Third Embodiment

An embodiment of a reflective display device will be described below. In this embodiment, guest-host liquid crystal (GH-LC) is used as the constituent element of the reflective display device. This liquid crystal is greatly adaptive to the manufacture of the display device according to the present embodiment because it can form a liquid crystal layer by coating.

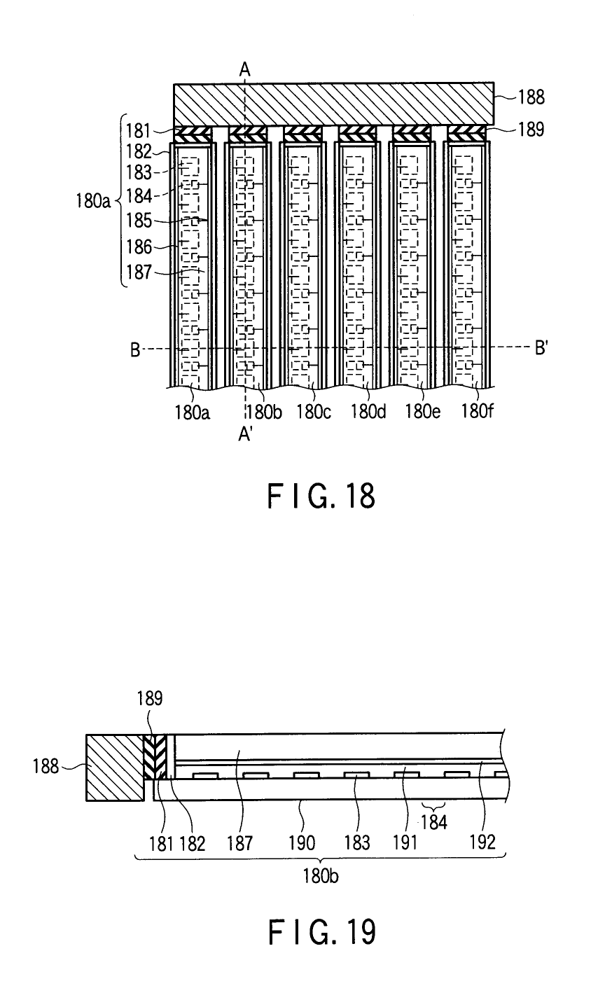

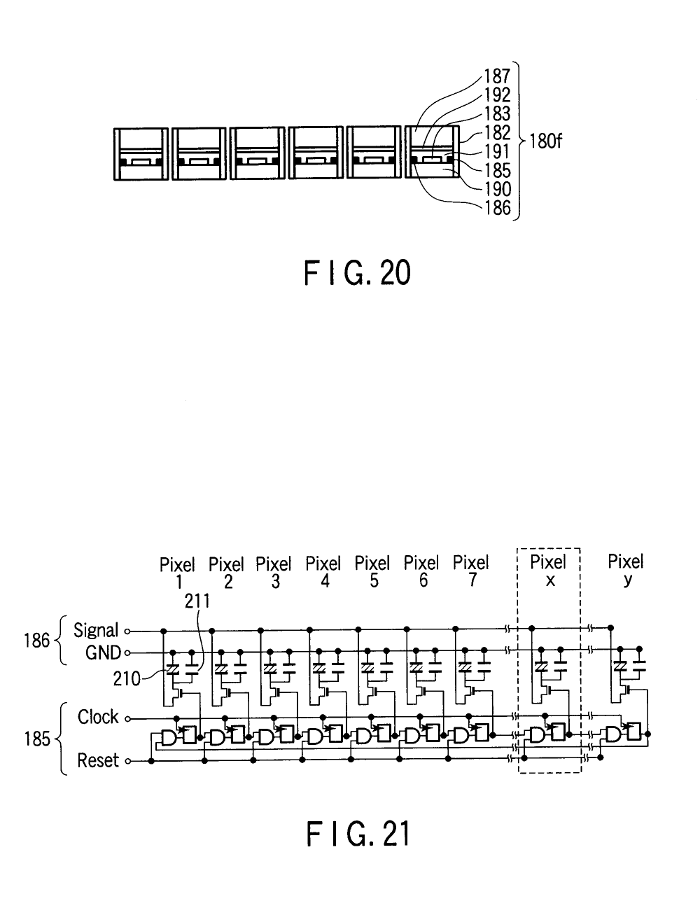

FIG. 18 shows an example of the arrangement of the display device according to this embodiment. FIGS. 19 and 20 show the cross section along a line A-A′ and the cross section along a line B-B′ in FIG. 18.

This device includes, as a one-dimensional device structure 180a, a connector 181, a sealing portion 182, pixel electrodes 183 that constitute pixels, inter-pixel circuits 184 formed on a support substrate 190 and arranged between the pixels, an inter-pixel circuit driving line 185 configured to operate the inter-pixel circuits 184, a signal driving line 186 configured to drive a liquid crystal layer 191 made of guest-host liquid crystal corresponding to the pixels, and a countersubstrate 187. The one-dimensional device structures 180a to 180f of this arrangement are independent structures, as in the first embodiment, and are connected to driving circuit unit connectors 189 of a driving circuit unit 188 via the connectors 181. Hence, the inter-pixel circuit driving lines 185 and the signal driving lines 186 of the one-dimensional device structures 180a to 180f are connected to the driving circuit unit 188 configured to drive the display device via the connectors.

Hence, in this embodiment as well, the pixels of the display device are one-dimensionally arrayed, and apparatus with a small installation can be applied to the manufacturing process for this device, as in the second embodiment. In addition, the circuit of the one-dimensional device structure including an active element such as a thin-film transistor can also be manufactured as in the second embodiment.

As for the reflective layer, the inter-pixel circuits 184 and the pixel electrodes 183 are formed on the support substrate 190 of the sectional structure shown in FIG. 19, as in the second embodiment. After that, guest-host liquid crystal is applied to the surface to form the liquid crystal layer 191 which is clamped by the support substrate and the countersubstrate 187 having a counterelectrode 192 formed in advance, thereby forming a liquid crystal cell structure. The counterelectrode 192 may be connected to ground potential via the connector 181 or connected at a position of the one-dimensional device structure corresponding to ground potential using, for example, silver paste.

FIG. 21 shows an example of the circuit arrangement of the one-dimensional device structure according to this embodiment. This circuit arrangement includes a signal line included in the signal driving line 186, a GND connected to a reference potential, a clock line and a reset line included in the inter-pixel circuit driving line 185, and, for each pixel, a circuit arrangement indicated by the broken line in FIG. 21. Note that in FIG. 21, the pixel electrodes 183 are defined as pixel 1, pixel 2, . . . , pixel y when viewed from the connector installation position, as in the first embodiment. Note that the liquid crystal layer 191 of each pixel is expressed using a hatched capacitor symbol 210. On the other hand, a capacitor symbol 211 connected in parallel with that capacitor represents a storage capacitor configured to suppress the potential change in the liquid crystal layer 191.

A method of operating each pixel according to this embodiment will be described next. Referring to FIG. 21, as for sequential scanning by the clock line and the reset line of the inter-pixel circuit driving line 185, the outputs shift sequentially from pixel 1 in accordance with signal input to the clock line, as in the second embodiment. After being shifted up to pixel y, the output can shift to pixel 1 in accordance with signal input to the reset line. Hence, it is possible to implement, in the one-dimensional device structure, the functions of a wiring line called a scanning line or a data line and a peripheral circuit configured to operate the line in the conventional display device, as in the second embodiment.

The output line from the circuit for controlling the sequential operation to each pixel is connected to the gate electrode of the thin-film transistor configured to operate the liquid crystal cell. The source (or drain) electrode is connected to the signal line included in the signal driving line 186. The drain (or source) electrode is connected to the GND line included in the signal driving line 186. With this arrangement, for example, when a gate voltage sufficient for the output line of pixel x to pass an on-current between the source and drain of the thin-film transistor is applied, the voltage (for example, Vx) that should drive the liquid crystal layer 191 of pixel x is synchronously applied to the signal line, thereby controlling the liquid crystal layer 191 to a desired reflective state. When the sequential operation shifts to pixel x+1 through the inter-pixel circuit driving line 185, the source-drain path of the thin-film transistor of pixel x can be set in a state corresponding to the off-current of the thin-film transistor. For this reason, the voltage Vx can almost be held independently of the voltage state of the signal line. It is therefore possible to change the reflective state of the liquid crystal layer 191 of pixel x+1 while holding the voltage in the reflective display. In this operation, the reflective state of the liquid crystal layer 191 can almost be held independently of the voltage state of the signal line in pixel 1, pixel 2, . . . , pixel y except pixel x+1.

Hence, in this embodiment as well, adopting the same display device arrangement as that shown in FIG. 17 enables a matrix operation even without wiring lines in the B-B′ direction in FIG. 18 called scanning lines or gate lines, unlike a normal display device. Even when a reflective element using guest-host liquid crystal is used as a pixel, adding the one-dimensional device structures and extending the driving circuit unit allow easy changing of the screen size on a unitary row of pixels, as in the first embodiment.

As described above, according to the embodiments, it is possible to provide a display device having a device structure (one-dimensional device structure) including one-dimensionally arrayed pixels. When the one-dimensional device structures are used, it is unnecessary to arrange the scanning lines that intersect the pixel arrays. The same operation as that of a two-dimensional matrix can be performed by simply arranging the one-dimensional device structures and connecting them to the driving circuit unit. In addition, it is possible to easily install a display device having an arbitrary screen size and an arbitrary number of pixels by adjusting the number of one-dimensional device structures to be connected to the driving circuit unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device in which one display screen is formed by a plurality of one-dimensional device structures, each of the one-dimensional device structures comprising:
a pixel array including a plurality of pixels arranged linearly;
a first driving line group configured to drive the pixel array;
a plurality of inter-pixel circuits arranged between a first pixel and a second pixel of the plurality of pixels to perform a sequential operation from the first pixel to the second pixel; and
a second driving line group configured to drive the inter-pixel circuits.

2. The device according to claim 1, wherein the first driving line group and the second driving line group are arranged parallel to the pixel array.

3. The device according to claim 1, further comprising a driving circuit unit configured to supply first driving signals to the first driving line group and supply second driving signals to the second driving line group,
wherein the first driving line group and the second driving line group are connected to the driving circuit unit at an end portion of each of the one-dimensional device structures.

4. The device according to claim 3, wherein the driving circuit unit has a plurality of connection portions to be connected to the end portion of each of the one-dimensional device structures, and
one of a display screen size and the number of display pixels is defined by the number of the one-dimensional device structures connected to the plurality of connection portions.

5. The device according to claim 3, wherein the driving circuit unit includes a plurality of circuits which are separated by the connection portions and connected to one or a plurality of one-dimensional device structures, and one of a display screen size and the number of display pixels is defined by the number of the plurality of circuits.
